(19) United States
(12) Patent Application Publication
(10) Pub. No.: US 2009/0017839 A1
(43) Pub. Date: Jan. 15, 2009

(54) WIRELESS NETWORK WITH ENHANCED SECURITY BY REAL-TIME IDENTIFICATION OF A LOCATION OF A RECEIVED PACKET SOURCE

(75) Inventor: Kyung-Hyun Kim, Vancouver (CA)

Correspondence Address: FIALA & WEAVER, P.L.L.C.;C/O INTELLEVATE, P.O. BOX 52050, MINNEAPOLLS, MN, 55402, US

(73) Assignee: BROADCOM CORPORATION, Irvine, CA (US)

(21) Appl. No.: 11/776,384

(22) Filed: Jul. 11, 2007

(51) Int. Cl. H04Q 7/20

(52) U.S. Cl. 455/456.1

(57) ABSTRACT

Methods, systems, and apparatuses for tracking client devices in a wireless communications network are provided. A bit sequence is received at three or more access points of the wireless communications network from a client device communicatively coupled to the wireless communications network. A physical location of the client device is determined based on a timing of receiving the bit sequence at the three or more access points. The determined physical location may be used to improve security with regard to the client device. If the determined physical location is outside of an acceptable area for the client device, the client device may be decoupled from the communications network and/or other security measures may be taken. In a further aspect, the client device may itself determine its physical location, and transmit an indication of its determined physical location in communication packets used to communicate with the network, for enhanced security.

### BACKGROUND OF THE INVENTION

1. Field of the Invention

The present invention relates to providing enhanced security for wireless networks.

2. Background Art

WiFi (wireless fidelity) systems relate generally to wireless local area networks (WLAN) based on one or more of the IEEE 802.11 specifications, and more broadly relate to the wireless interfacing of mobile computing devices (e.g., laptops, handheld computers, cell phones, etc.) with LANs. WiFi systems are being increasingly implemented in society, frequently being available in governmental, corporate, commercial, public “hotspot,” and home environments. WiFi systems enable users of mobile computing devices to communicate with devices coupled to the LAN and to communicate over the Internet, without needing a wire or cable to make the connection.

A typical WiFi system includes one or more access points (APs). Client mobile devices connect to the WiFi system through the APs. When one or more APs are in communication range of a client, the client may select the AP providing the strongest signal for connection. A client may roam through a space covered by multiple APs, switching from one AP to another AP during its movement, for communication with the network.

Current WiFi networks, such as those implemented in corporate environments, lack sufficient security to prevent unwanted usage by intruder devices. For example, a WiFi network at a particular corporate facility may be intended for use by employees of the corporation. However, an intruder device may be able to connect to the WiFi network from outside the facility, such as in the parking lot of the facility, if a signal from an AP can be received there. The intruder device may be able to access corporate information using the WiFi network in an unwanted manner.

Thus, what are needed are WiFi networks with improved security to prevent access by undesired intruders.

### BRIEF SUMMARY OF THE INVENTION

Methods, systems, and apparatuses for tracking client devices in a wireless communications network are provided. Embodiments of the present invention enable client devices of a network to be located in real-time. The determined locations of the client devices may be used in various security applications.

In an example aspect of the present invention, a client device is communicatively coupled to a wireless communications network. A bit sequence is received at three or more access points of the wireless communications network from the client device. A physical location of the client device is determined based on a timing of receiving the bit sequence at the three or more access points.

The determined physical location may be used to improve security with regard to the client device. If the determined physical location is outside of an acceptable area for the client device, the client device may be decoupled from the communications network and/or other security measures may be taken.

In another example aspect of the present invention, a wireless communications network includes a location determiner module. The location determiner module is configured to determine a physical location of a client device communicatively coupled to the network based on a timing of receipt of a bit sequence from the client device at three or more access points of the network.

In a further example, the network includes a security module. The security module is configured to determine whether the determined physical location is outside a region authorized for operation of the client device, and to cause the client device to be decoupled from the wireless communications network, and/or perform other security measure, if the determined physical location is determined to be outside the region.

In another example aspect of the present invention, a method for a client device to communicate with a wireless communication network is provided. A local clock signal is generated by the client device that is synchronized with a clock signal of the network. A bit of a pseudo random bit sequence is generated in the client device. The generated bit is transmitted at a predetermined value of the local clock signal. Bits of the pseudo random bit sequence are repeatedly generated and transmitted at periodic values of the local clock signal. A plurality of access points of the wireless communications network are configured to receive the transmitted bits of the pseudo random bit sequence and to determine a physical location of the client device based on a timing of receipt of the transmitted bits.

In an example, the client device includes a radio frequency (RF) communication module, a clock generator, and a pseudo random bit sequence generator. The RF communication module is configured to enable wireless communications over the wireless communications network. The clock generator is configured to generate the local clock signal synchronized with the network clock signal. The pseudo random bit sequence generator is configured to generate the bits of the pseudo random bit sequence. The RF communication module is configured to transmit bits of the generated bits at predetermined values of the local clock signal.

In a further example, a plurality of pseudo random bit sequences are generated by access points of the network. The pseudo random bit sequences are received at the client device from the access points. The client device further includes a location determiner module. The location determiner module is configured to determine a physical location of the client device based on a timing of receiving bits of the plurality of pseudo random bit sequences.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an example conventional WiFi network.

FIG. 2 shows a block diagram of an example WiFi network, according to an embodiment of the present invention.

FIG. 3 shows a flowchart providing example steps for tracking client devices in a wireless communications network, according to an example embodiment of the present invention.

FIG. 4 shows a block diagram of an example WiFi network, according to an embodiment of the present invention.

FIG. 5 shows a block diagram of a location determining module, according to an example embodiment of the present invention.

FIG. 6 shows a flowchart providing example steps for connecting a client device to a wireless communications network, according to an example embodiment of the present invention.

FIG. 7 shows an access point communicating with a client device, according to an example embodiment of the present invention.

FIG. 8 shows a block diagram of an example synchronization module, according to an embodiment of the present invention.

FIG. 9 shows a block diagram of an example client device, according to an embodiment of the present invention.

FIG. 10 shows a flowchart for operation of a client device, according to an example embodiment of the present invention.

FIG. 11 shows a flowchart providing example steps for determining the location of a client device, according to an example embodiment of the present invention.

FIG. 12 shows a block diagram of access points configured to generate a physical location determination for a client device, according to an example embodiment of the present invention.

FIG. 13 shows a block diagram of access points determining a location of a client device, according to an example embodiment of the present invention.

FIG. 14 shows an intersecting circles algorithm that may be used to locate a client device, according to an example embodiment of the present invention.

FIG. 15 shows a block diagram of an example client device, according to an embodiment of the present invention.

FIG. 16 shows a flowchart providing example steps for a client device to determine its location, according to an example embodiment of the present invention.

FIG. 17 shows communications between a client device and access points of a network, according to an example embodiment of the present invention.

FIG. 18 shows a flowchart providing example steps for authorizing a client device, according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### Example Wireless Networks

Embodiments of the present invention relate to WiFi systems/networks. WiFi relates generally to wireless local area networks (WLAN) based on one or more of the IEEE 802.11 specifications, and more broadly relates to the wireless interfacing of mobile computing devices (e.g., laptops, handheld computers, cell phones, etc.), also referred to as “clients” or “client devices,” with local area networks (LANs). WiFi systems enable users of the client devices to communicate with devices coupled to the LAN and to communicate over the Internet, without needing a wire or cable connected between the client device and network.

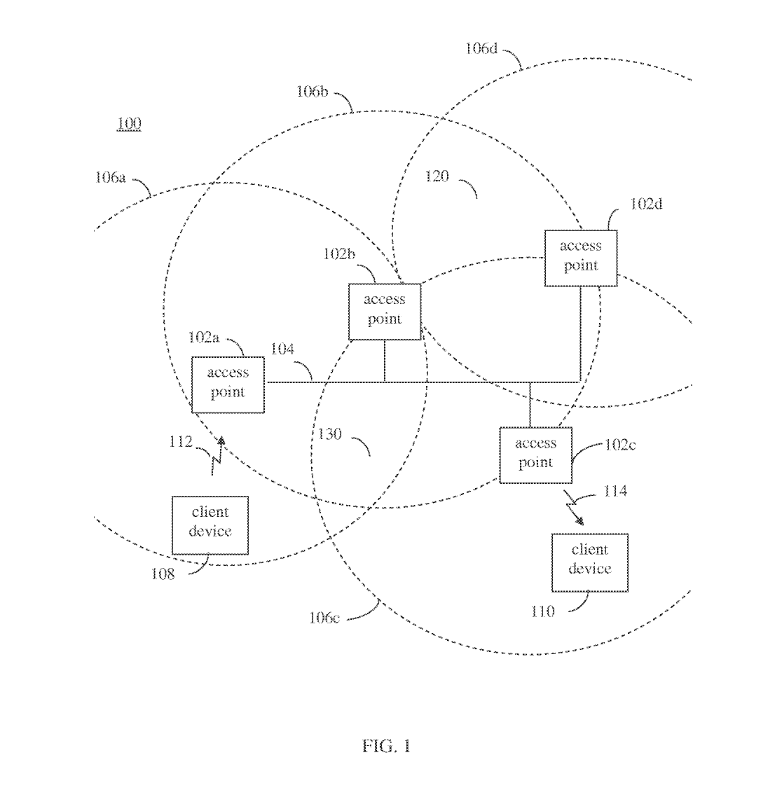

FIG. 1 shows an example WiFi network 100. As shown in FIG. 1, network 100 includes a plurality of access points (APs) 102a-102d and a communication link 104. APs 102 may also be referred to as wireless access points (WAPs). APs 102 are wireless networking devices, such as wireless routers. Any number of APs 102 may be present in a WiFi network. Each of APs 102a-102d has a respective communication range 106a-106d, which may overlap. For example, communication ranges 106b and 106d of APs 102b and 102d overlap in an oval shaped region 120, and thus a client device located in region 120 can communicate over network 100 by connecting with either of APs 102b and 102d. In another example, communication ranges 106a-106c of APs 102a-102c overlap in a region 130 having an oval shape with a truncated end. Any number of communications ranges 106 may overlap at any particular location, depending on a number and configuration of APs 202 that are present.

APs 102a-102d are coupled together by communication link 104. Communication link 104 may include one or more wired and/or wireless communication sub-links. For example communication link 104 may include a wired Ethernet network, and may include one or more switches, bridges, and/or hubs. Communications between client devices through network 100 may pass through communication link 104. Communication link 104 may further include a connection to another network, such as the Internet.

APs 102 relay data between connected wireless clients, such as client devices 108 and 110 shown in FIG. 1. As shown in FIG. 1, after connecting to access point 102a, client device 108 can wirelessly transmit a communications packet 112 that includes data. Communications packet 112 is received by access point 102a, because client device 108 is within communication range 106a of access point 102a. Access point 102a transmits the data of communications packet 112 through communication link 104 to access point 102c. Access point 102c wirelessly transmits a communications packet 114 to client device 110 that includes the data.

Client devices 108 and 110 may be stationary devices (e.g., printers, desktop computers, etc.) or mobile devices, such as cell phones, music players, mobile handheld computers (e.g., personal digital assistants (PDA), PALM devices, BLACKBERRY devices, etc.), other types of mobile computers (e.g., laptops, notebook computers), etc. Mobile client devices may roam through a space covered by network 100, switching from one to another of APs 102a-102d during their movement, for communications using network 100.

In an embodiment, clients 108 and 110 and APs 102a-102d communicate with each other according to a proprietary or standard WLAN protocol. For example, in an embodiment, communications between clients and APs in network 200 are configured according to one or more of the IEEE 802.11 standards. Alternatively, other wireless communication protocols may be used for communications between clients and APs in network 200.

Current WiFi networks, such as those implemented in corporate environments, lack sufficient security to prevent unwanted usage by intruder devices. For example, a WiFi network at a particular corporate facility may be intended for use by employees of the corporation. However, an intruder device may be able to connect to the WiFi network from outside the facility, such as in the parking lot of the facility, if a communication range of an AP extends outside the facility. The intruder device may be able to access corporate information or perform other undesired behavior by accessing the WiFi network.

Embodiments of the present invention overcome these limitations of present WiFi networks. In embodiments, a WiFi network is configured to determine locations of connected mobile client devices. In this manner, the locations of the mobile client devices can be monitored to determine whether mobile client devices are attempting to communicate over the WiFi network from undesired locations, such as outside of a facility in which the WiFi network resides.

Example embodiments of the present invention are described in detail in the following section.

### Example Embodiments

The example embodiments described herein are provided for illustrative purposes, and are not limiting. The examples described herein may be adapted to any type of WiFi network. Furthermore, additional structural and operational embodiments, including modifications/alterations, will become apparent to persons skilled in the relevant art(s) from the teachings herein. Embodiments of the present invention enable the location of client devices of a wireless network to be determined, in real-time. The determined location may be used in various security applications.

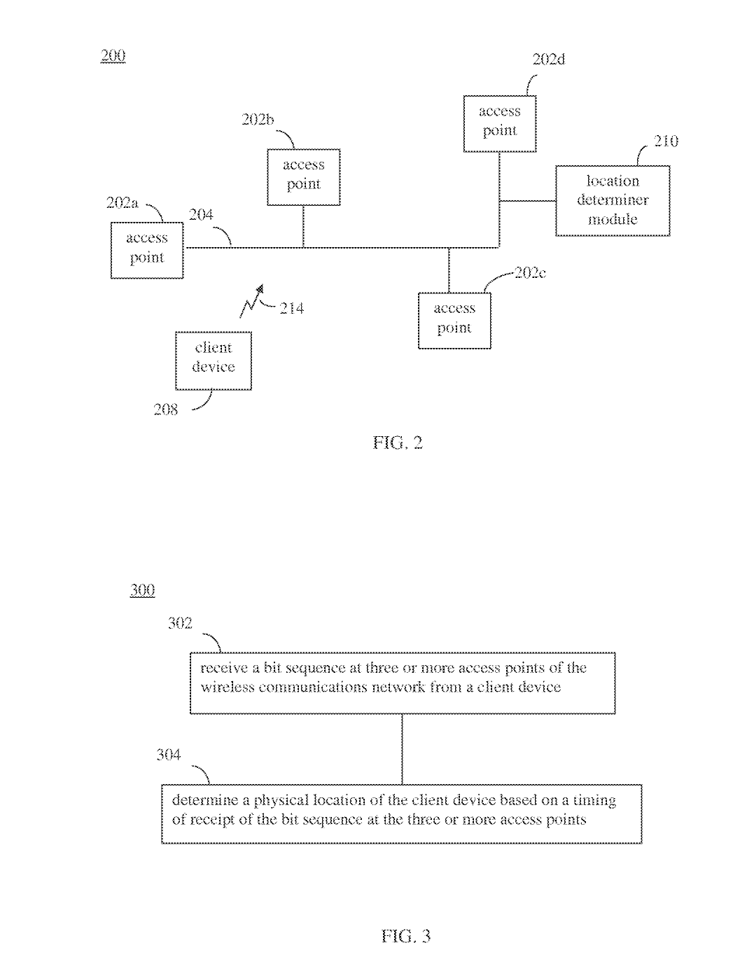

FIG. 2 shows a WiFi network 200, according to an example embodiment of the present invention. As shown in FIG. 2, WiFi network 200 includes a plurality of access points (APs) 202a-202d, a communication link 204, and a location determiner module 210. WiFi network 200 is similar to WiFi network 100 shown in FIG. 1, with similarly named elements having generally similar functions, and with differences discussed below.

As shown in FIG. 2, location determiner module 210 is coupled to communication link 204. Location determiner module 210 is configured to determine a physical location of a client device, such as client device 208, that is communicatively coupled to network 200. As shown in FIG. 2, client device 208 transmits a bit sequence 214. In an embodiment, location determiner module 210 determines the physical location of client device 208 based on a timing of receipt of bits of bit sequence 214 at three or more of access points 202a-202d.

FIG. 3 shows a flowchart 300 providing example steps for tracking client devices in a wireless communications network, according to an example embodiment of the present invention. For example, access points 202 and location determiner module 210 of network 200 may perform the operation of flowchart 300 to determine a location of client device 208. Other structural and operational embodiments will be apparent to persons skilled in the relevant art(s) based on the discussion regarding flowchart 300. Flowchart 300 is described as follows.

Flowchart 300 begins with step 302. In step 302, a bit sequence is received at three or more access points of the wireless communications network from a client device. For example, as shown in FIG. 2, client device 208 transmits a bit sequence 214 to network 200. Bit sequence 214 may include one or more bits of a generated sequence transmitted in one or more communication packets. Bit sequence 214 is received by a three or more of APs 202. For example, in FIG. 2, APs 202a-202c, which are the closest APs to client device 208, receive bit sequence 214. Access point 202d and/or further APs of network 200 may also receive bit sequence 214.

In step 304, a physical location of the client device is determined based on a timing of receipt of the bit sequence at the three or more access points. For example, in an embodiment, a timing of the receipt of bits of bit sequence 214 at each of access points 202a-202c is used to determine a location of physical location of client device 208. Various techniques can be used to determine the location of client 208 based on the timing of receipt of bits of bit sequence 214 at three or more access points. Example embodiments for steps 302 and 304 are described in further detail below.

As described above network 200 and flowchart 300 can be used to provide security. In an example embodiment, network 200 is implemented in a facility. Network 200 is implemented in a manner such that at least three APs 202 of the facility have communication ranges 106 that cover areas of interest. As long as client device 208 is within the areas of interest, its movement can be tracked by the three or more APs 202. The areas of interest may include areas within the facility and/or outside areas surrounding a perimeter of the facility. In one example, the areas within the facility may be acceptable areas and the outside areas may be unacceptable areas for presence of client device 208. By determining a physical location of client device 208 with regard to the facility, it can be determined whether client device 208 is located in an acceptable area or in an unacceptable area. If client device 208 is determined to be located in an unacceptable area, client device 208 can be decoupled from network 200, disallowing client device 208 from further communications using network 200.

In another security related embodiment, client device 208 may be coupled to an item with the facility that should not be moved out of the facility (or to other unacceptable area). For example, the item may be an important piece of equipment used in the facility. The physical location of the item can be tracked by having client device 208 coupled to the item, and transmitting bit sequence 214. As long as the item is determined to be located in an acceptable area, no action is taken. If the item is determined to be located in an unacceptable area, it can be assumed that someone may be stealing or otherwise interacting with the item in an undesired manner, and appropriate security measures may be taken.

Further security applications for network 200 and flowchart 300 will be apparent to persons skilled in the relevant art(s) from the teachings herein. Such further security applications are within the scope and spirit of embodiments of the present invention.

In embodiments, location determiner module 210 may be implemented in hardware, software, firmware, of any combination thereof. For example, location determiner module 210 may be implemented in digital logic, such as in an integrated circuit (e.g., an application specific integrated circuit (ASIC)), in code configured to execute in one or more processors, and/or in other manner as would be known to persons skilled in the relevant art(s).

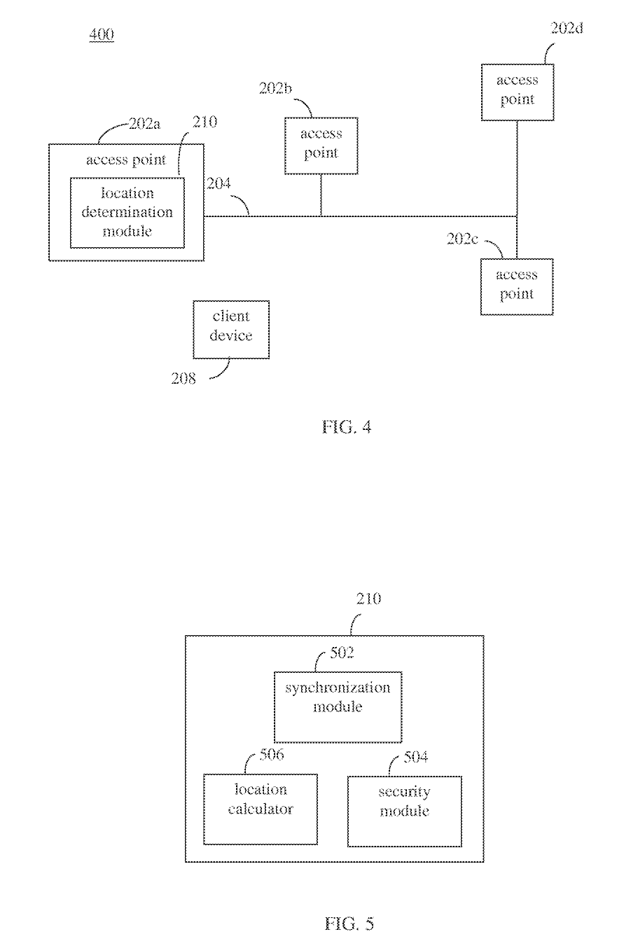

Note that in the example of FIG. 2, location determiner module 210 is shown coupled to communication link 204. Location determiner module 210 may reside in a computing device such as a computer system, a special purpose device, or other device that can be coupled to communication link 204. In another embodiment, location determiner module 210 may be implemented in one or more access points, such as AP 202a, as shown in FIG. 4. Location determiner module 210 may be implemented in a chip, such as in a chip with IEEE 802.11 standard transceiver functionality.

FIG. 5 shows an example block diagram of location determiner module 210, according to an embodiment of the present invention. As shown in FIG. 5, location determiner module 210, includes a synchronization module 502, a security module 504, and a location calculator 506. Synchronization module 502 is used to synchronize client device 208 according to an example embodiment of the present invention. Location calculator 506 is configured to calculate a physical location of client device 208. Security module 504 is configured to determine whether the physical location for client device 208 determined by location calculator 506 is outside a region authorized for operation of client device 208, and to enable appropriate security measures to be taken. Example embodiments for synchronization module 502, security module 504, and location calculator 506 are described in further detail below.

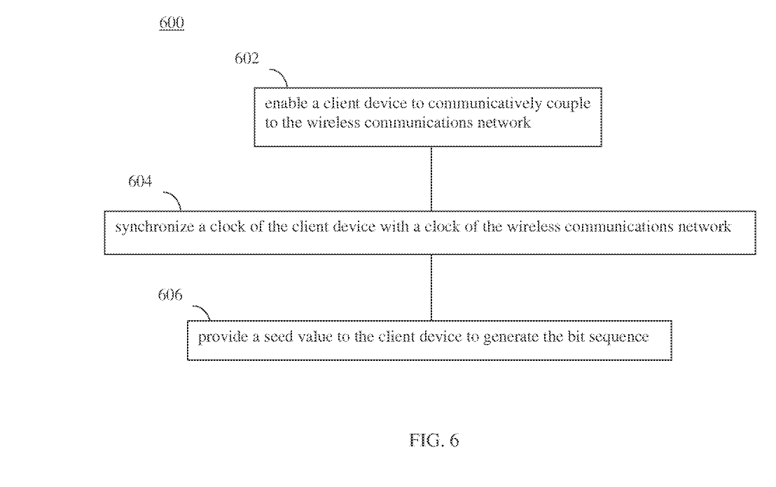

FIG. 6 shows a flowchart 600 providing example steps for connecting a client device to a wireless communications network, according to an example embodiment of the present invention. In an embodiment, steps 604 and 606 of flowchart 600 may be performed by synchronization module 502. The steps of flowchart 600 do not need to be performed in the order shown in all embodiments. Flowchart 600 is described as follows.

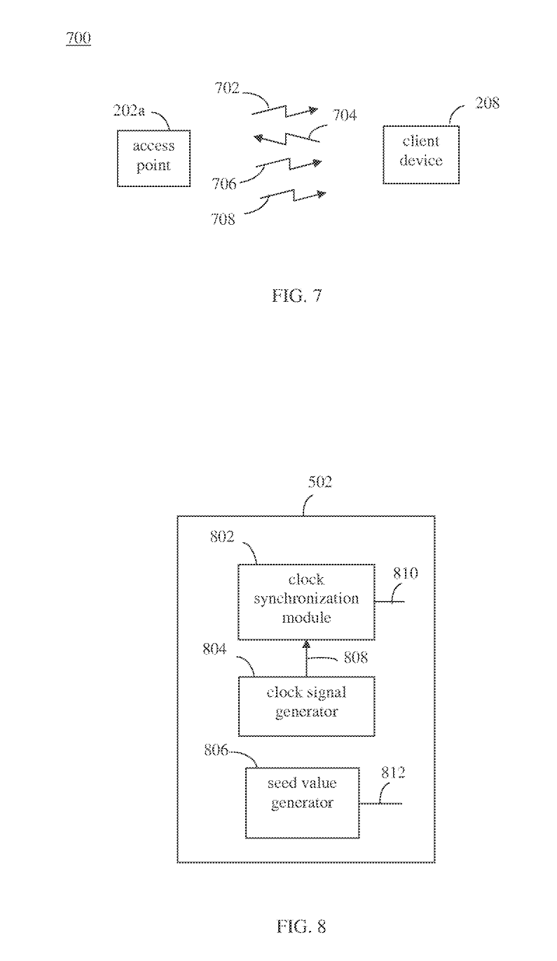

In step 602, a client device is enabled to communicatively couple to the wireless communications network. For example, client device 208 may connect to an access point 202 in a standard fashion. For instance, in an IEEE 802.11 standard embodiment, APs 202 each broadcast their respective SSID (Service Set Identifier) in a communication packet called a beacon. The beacons are transmitted periodically, such as every 100 ms. FIG. 7 shows a portion 700 of network 200 where client device 208 is enabled to communicatively couple to AP 202a. As shown in FIG. 7, client device 208 receives a first communication signal 702 from AP 202a, which includes a beacon. Client device 208 responds to first communication signal 702 with a second communication signal 704 to log into AP 202a. Client device 208 provides login and password information, for example.

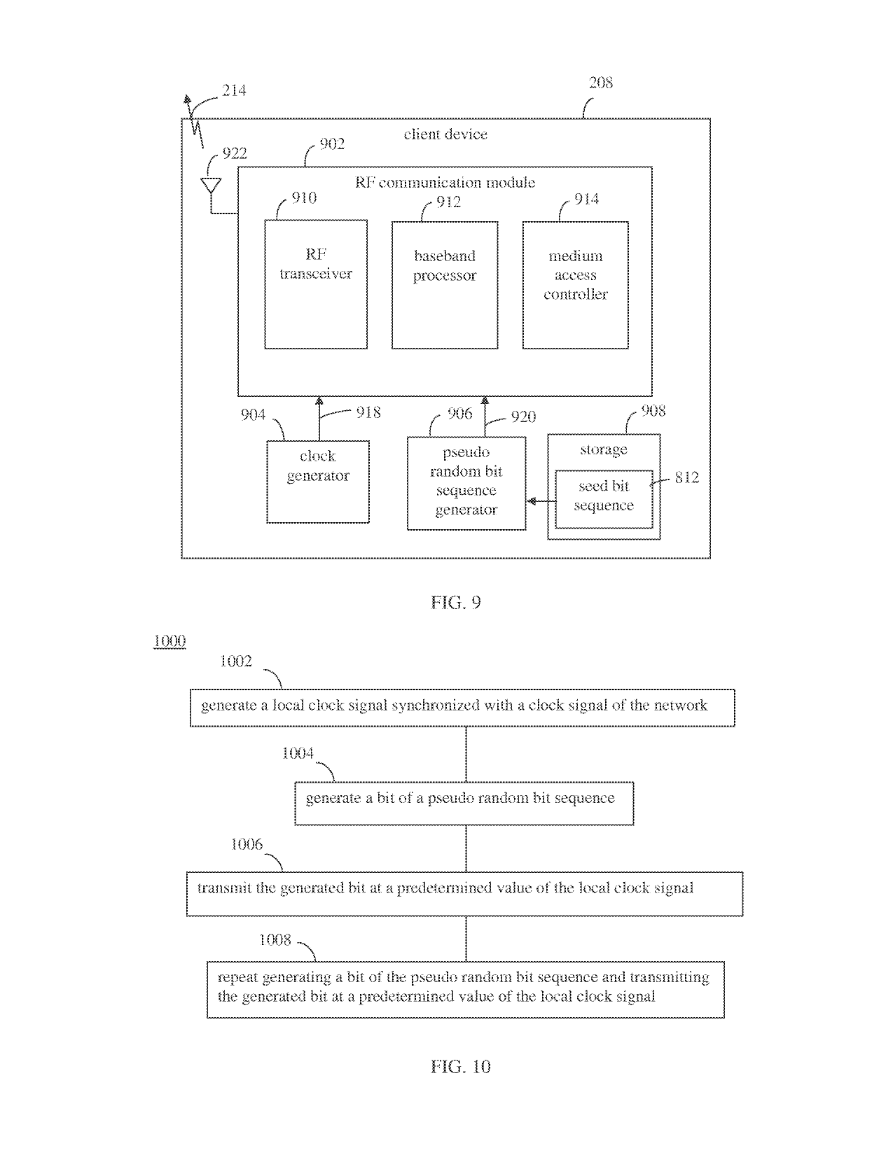

In step 604, a clock of the client device is synchronized with a clock of the wireless communications network. For example, as shown in FIG. 7, access point 202a transmits a third communication signal 706 to client device 208 that includes clock synchronization information. FIG. 8 shows an example embodiment of synchronization module 502 of FIG. 5. As shown in FIG. 8, synchronization module 502 includes a clock synchronization module 802, a clock signal generator 804, and a seed value generator 806.

Clock synchronization module 802 is configured to synchronize a clock of client device 208 with clock signal 808. Clock signal generator 804 generates a clock signal 808. Clock signal 808 is a clock signal for AP 202a that is synchronized with clock signals of other APs 202 of network 200. As shown in FIG. 8, clock synchronization module 802 receives clock signal 808 from clock signal generator 804. Clock synchronization module 802 generates clock synchronization information 810. Clock synchronization information 810 is transmitted in third communication signal 706 to client device 208. Clock synchronization information 810 is used by client device 208 to synchronize a local clock signal of client device 208 with clock signal 808 of AP 202a. For example, clock synchronization information 810 may include a clock value of clock signal 808 of AP 202a. In an embodiment, clock synchronization information 810 may include information to account for a time delay inherent in transmitting clock synchronization information 810 to client device 208. Techniques for synchronizing clock signal 808 with a clock of client device 208 will be known to person skilled in the relevant art(s), and thus are not described in detail herein for reasons of brevity.

In step 606, a seed value is provided to the client device to generate the bit sequence. For example, as shown in FIG. 7, access point 202a transmits a fourth communication signal 708 to client device 208 that includes the seed value. As shown in FIG. 8, seed value generator 806 of synchronization module 502 provides a seed value 812. Seed value generator 806 may store a list of seed values, and may select seed value 812 from the list, or may generate seed value 812 on a case by case basis. Seed value 812 is provided to client device 208 in fourth communication signal 708. Furthermore, seed value 812 is provided to other APs 202 in network 200. Client device 208 uses seed value 812 to generate bit sequence 214 transmitted to network 200 (as shown in FIG. 2).

FIG. 9 shows an example block diagram for client device 208, according to an embodiment of the present invention. As shown in FIG. 9, client device 208 includes a radio frequency (RF) communication module 902, a clock generator 904, a pseudo random bit sequence generator 906, storage 908, and an antenna 922.

RF communication module 902 is configured to enable wireless communications over network 200 for client device 208. For example, as shown in FIG. 9, in an embodiment, RF communication module 902 may include an RF transceiver 910, a baseband processor 912, and a medium access controller (MAC) 914. Transceiver 910 is configured to down-convert and demodulate communication signals received at antenna 922 from APs 202, and output received data (such as I and Q data). Furthermore, transceiver 910 is configured to modulate and up-convert data signals to be transmitted from client device 208 by antenna 922. Baseband processor 912 may be configured to modulate and demodulate I and Q data, perform carrier sensing, and/or other functions for RF communication module 902. MAC 914 is configured to control the communications between client device 208 and APs 202.

Transceiver 910 may include a receiver and transmitter that are separate, or a combined transceiver. Transceiver 910, baseband processor 912, and MAC 914 may be implemented in hardware, software, firmware, or any combination thereof, as would be known to persons skilled in the relevant art(s).

Clock generator 904 is configured to generate a local clock signal 918 that is synchronized with a clock signal of network 200. For example, RF communication module 902 may receive clock synchronization information 810 transmitted in third communication signal 706 to client device 208, as shown in FIG. 7. Clock generator 904 may use clock synchronization information 810 to synchronize local clock signal 918 with clock signal 808 shown in FIG. 8.

Pseudo random bit sequence generator 906 is configured to generate bits of a pseudo random bit sequence 920. As shown in FIG. 9, storage 908 stores seed bit sequence 812, which is received by client device 208 in fourth communication signal 708, as described above with reference to FIG. 7. Pseudo random bit sequence generator 906 uses seed bit sequence 812 as a seed for generating pseudo random bit sequence 920. Pseudo random bit sequence 920 is a sequence of bits that approximates one or more properties of a random bit string, but is deterministic. Pseudo random number generators are well known to persons skilled in the relevant art(s).

RF communication module 902 receives pseudo random bit sequence 920 and clock signal 918, and is configured to transmit one or more bits of pseudo random bit sequence 920 at predetermined values of clock signal 918 as bit sequence 214. For example, in an embodiment, RF communication module 902 may transmit one bit of pseudo random bit sequence 920 at periodic points in time indicated by clock signal 918.

RF communication module 902, clock generator 904, pseudo random bit sequence generator 906, and storage 908 may be implemented in hardware, software, firmware, or any combination thereof, as would be known to persons skilled in the relevant art(s). For example, RF communication module 902, clock generator 904, pseudo random bit sequence generator 906, and storage 908 may be implemented together in an integrated circuit chip, such as a WiFi chip that may be used in mobile devices.

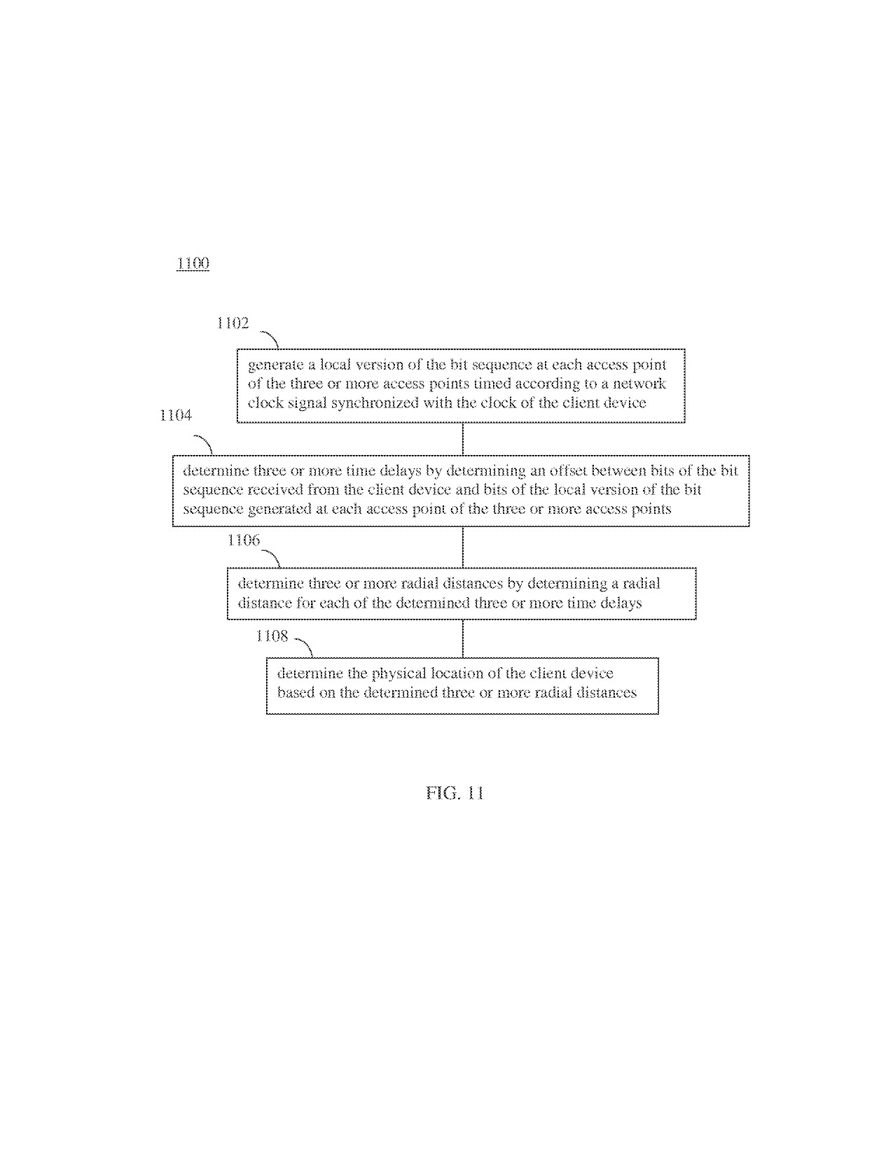

FIG. 10 shows a flowchart 1000 providing example steps for operation of client device 208 shown in FIG. 9, according to an example embodiment of the present invention. Flowchart 1000 is described as follows.

In step 1002, a local clock signal synchronized with a clock signal of the network is generated. For example, as described above, clock generator 904 of client device 208 shown in FIG. 9 generates local clock signal 918. Local clock signal 918 is synchronized with clock signal 808 of AP 202a shown in FIG. 8.

In step 1004, a bit of a pseudo random bit sequence is generated. For example, in an embodiment, pseudo random bit sequence generator 906 of client device 208 shown in FIG. 9 generates a first bit of pseudo random bit sequence 920.

In step 1006, the generated bit is transmitted at a predetermined value of the local clock signal. For instance, as described above with respect to FIG. 9, RF communication module 902 may transmit a generated bit of pseudo random bit sequence 920 at a predetermined time value of local clock signal 918.

In step 1008, the generation of a bit of the pseudo random bit sequence and transmission of the generated bit at a predetermined value of the local clock signal is repeated. In embodiments, pseudo random bit sequence generator 906 may continue to generate next bits of pseudo random bit sequence 920, which are transmitted periodically at predetermined time values of local clock signal 918. Access points 202 of network 200 receive the transmitted bits, and determine a physical location of client device 208 based on a timing of receipt of the transmitted bits.

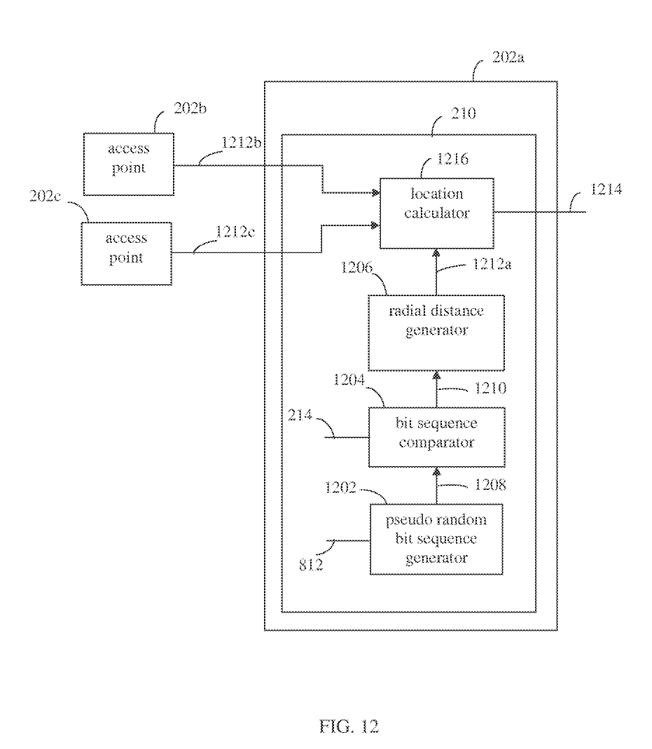

For example, referring back to FIG. 5, location determiner module 210 is configured to determine a physical location of client device 208 based on a timing of receipt of the bits. FIG. 11 shows a flowchart 1100 providing example steps for determining the location of a client device in this manner, according to an example embodiment of the present invention. For example, step 304 shown in FIG. 3 may be performed according to flowchart 1 100. The steps of flowchart 1100 do not need to be performed in the order shown in all embodiments. Flowchart 1100 is described as follows with respect to FIG. 12, for illustrative purposes. FIG. 12 shows APs 202a-202c, configured according to an embodiment of the present invention. In FIG. 12, AP 202a is shown including location determiner module 210. In the embodiment of FIG. 12, location determiner module 210 includes a pseudo random bit sequence generator 1202, a bit sequence comparator 1204, a radial distance generator 1206, and a location calculator 1216. APs 202b and 202c may contain similar functionality to AP 202a in FIG. 12, but such functionality is not shown for purposes of brevity.

In step 1102, a local version of the bit sequence is generated at each access point of the three or more access points timed according to a network clock signal synchronized with the clock of the client device. In an embodiment, APs 202 may each include a pseudo random number generator 1202, as shown in FIG. 12. Pseudo random bit sequence generator 1202 receives seed bit sequence 812, which may be stored in each AP 202. Pseudo random bit sequence generator 1202 is configured similarly to pseudo random bit sequence generator 906 of client device 208. Pseudo random bit sequence generator 1202 receives seed bit sequence 812, and generates a pseudo random bit sequence 1208 that matches pseudo random bit sequence 920 generated by pseudo random bit sequence generator 906. Because clock signal generators 804 of APs 202 are synchronized with clock generator 904 of client device 208, pseudo random bit sequence generator 1202 and pseudo random bit sequence generator 906 output the same bits at the same time. For example, pseudo random bit sequence 1208 and pseudo random bit sequence 920 may be generated as shown in Table 1:

TABLE 1

| | time A | time B | time C | time D |
|---|---|---|---|---|
| pseudo random bit | 1 | 0 | 1 | 1 |
| sequence 1208 | | | | |
| pseudo random bit | 1 | 0 | 1 | 1 |
| sequence 920 | | | | |

As shown in Table 1, the same bits (a bit sequence of 1011) are generated for pseudo random bit sequence 1208 and pseudo random bit sequence 920 at the same times (times A-D).

According to step 1102, pseudo random bit sequence generators 1202 of three or more APs 202, such as APs 202a-202c shown in FIG. 2, generate pseudo random bit sequences 1208.

In step 1104, three or more time delays are determined by determining an offset between bits of the bit sequence received from the client device and bits of the local version of the bit sequence generated at each access point of the three or more access points. Each AP 202 may include a bit sequence comparator 1204. Bit sequence comparator 1204 receives bit sequence 214, received from client device 208, and receives pseudo random bit sequence 1208. Bit sequence comparator 1204 compares bit sequence 214 and pseudo random bit sequence 1208 to determine a time delay for bits from client device 208 to be received by the particular AP 202. As described above with respect to Table 1, pseudo random bit sequence 1208 and pseudo random bit sequence 920 are generated to match in a time-wise fashion. However, bit sequence 214 received by an AP 202 is a delayed version of pseudo random bit sequence 920 generated at client device 208 due to a transit time for the bits between client device 208 and the particular AP 202. Thus, an offset in bits between received bit sequence 214 and pseudo random bit sequence 1208 can be used to determine a time delay for the bits due to transit time.

For example, following the example of Table 1, Table 2 below shows an example of bit sequence 214 and pseudo random bit sequence 1208 compared in a bit sequence comparator 1204 of a particular AP 202 (NR is entered in cells of Table 2 where bit values may appear, but are not relevant in the present example):

TABLE 2

| | time A | time B | time C | time D | time E | time F | time G |
|---|---|---|---|---|---|---|---|
| pseudo random bit | 1 | 0 | 1 | 1 | NR | NR | NR |
| sequence 1208 | | | | | | | |
| bit sequence 214 | NR | NR | NR | 1 | 0 | 1 | 1 |

As shown in Table 2, bit sequence 214 is delayed by three time periods relative to pseudo random bit sequence 1208. Thus, three time periods were required for bit sequence 214 to be received from client device 208 at the particular AP 202. Bit sequence comparator 1204 generates a time delay value 1210, which is a sum of time period delays. For example, in Table 2, time delay value 1210 is three time periods.

According to step 1104, bit sequence comparators 1204 of three or more APs 202, such as APs 202a-202c shown in FIG. 2, generate time delay values 1210, based on their respective time delays in receiving bit sequence 214. Each time delay value 1210 will vary depending on a distance between client device 208 and the particular one of APs 202a-202c.

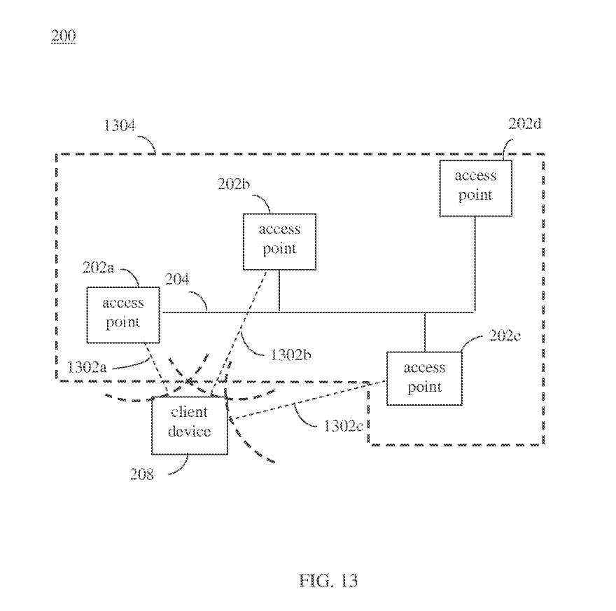

In step 1106, three or more radial distances are determined by determining a radial distance for each of the determined three or more time delays. Each AP 202 may include a radial distance generator 1206, in an embodiment. Alternatively, radial distance generation may be performed in a single location, such as in AP 202a. As shown in FIG. 12, radial distance generator 1206 receives time delay 1210. Radial distance generator 1206 calculates a radial distance between client device 208 and the particular AP 202 based on time delay 1210. FIG. 13 indicates example radial distances 1302a-1302b between client device 208 and access points 202a-202c, respectively. In an embodiment, radial distance generator 1206 multiplies time delay 1210 by a radial distance factor, RDF, having units of distance/time, to determine a radial distance, which is output by radial distance generator 1206 as a radial distance 1212:

radial distance 1212=RDF×time delay 1210. Equation 1

In an example, the radial distance factor RDF is based on a velocity of bit stream 214 through the air medium, closely related to the speed of light. In another embodiment, Equation 1 may be modified to account for time delays (e.g., data buffering delays, etc.) inherent in AP 202 and/or client device 208.

According to step 1104, a radial distance 1212 is determined for three or more APs 202, such as APs 202a-202c shown in FIG. 2. As shown in FIG. 12, access point 202b outputs a radial distance 1212b, and access point 202c outputs a radial distance 1212c. Location calculator 1216 outputs radial distance 1212a for access point 202a.

In step 1108, the physical location of the client device is determined based on the determined three or more radial distances. As shown in FIG. 12, location calculator 1216 in access point 202a receives radial distances 1212a-1212c. Location calculator 1216 determines a physical location of client device 208 based on radial distances 1212a-1212c. Location calculator 1216 may take into account a known location of access points 202a-202c when determining the physical location of client device 208. As shown in FIG. 12, location calculator 1216 generates a physical location indication 1214 that indicates the determined physical location of client device 208.

A variety of techniques are known to persons skilled in the relevant art(s) for making a location determination based on such information. For instance, techniques of triangulation or trilateration may be used to determine a location of client device 208.

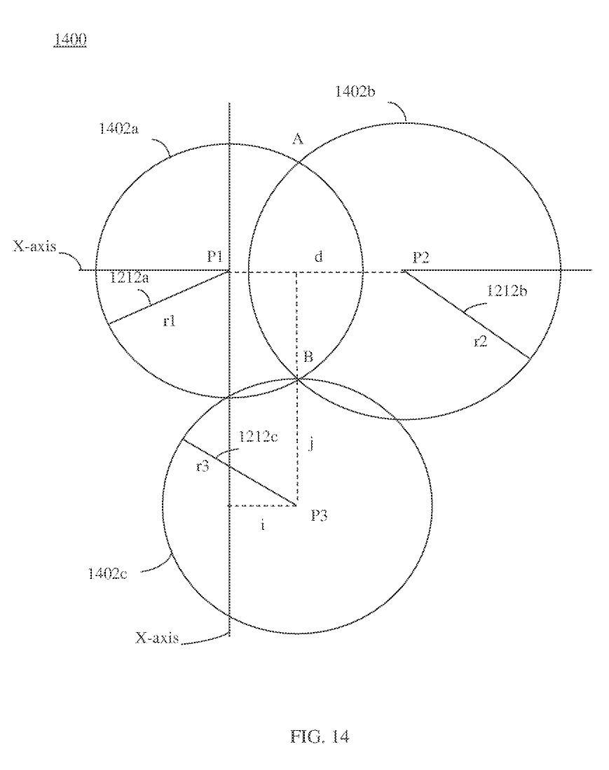

For example, the following technique may be used in location calculator 1216, based on an intersection of circles having radii of three or more determined radial distances 1212. The following example illustrates location determination using three radial distances 1212, but the technique may be extended to using further radial distances 1212. FIG. 14 shows a coordinate system 1400 in which are shown three circles 1402a-1402c. A center (P1-P3) of each of circles 1402a-1402c corresponds to a respective example location of one of access points 202a-202c. Each of circles 1402a-1402c has a respective radius of a corresponding one of determined radial distances 1212a-1212c. A location “B” indicates the actual location of client device 208. In the current example, a center P1 for access point 1202a is set to the origin of an X-axis and a Y-axis. A distance between centers P1 (access point 1202a) and P2 (access point 1202b) is indicated as “d.” A right angle distance between center point P3 (access point 1202c) and a line formed along distance “d” between center points P1 and P2 is indicated as “j.” A portion of distance “d” between center point P1 and an intersection of the line formed along distance “d” and a line formed along distance “j” is indicated by “i.” In coordinate system 1400, (x , y) values for the coordinates of client device 208 at location B can be calculated as follows:

$$x = \frac{{r}_{1}^{2} - {r}_{2}^{2} + {d}^{2}}{2 d} , \\ \text{and}$$

$$y = \frac{{r}_{1}^{2} - {r}_{3}^{2} + {i}^{2} + {j}^{2}}{2 j} - \frac{i}{j} x ,$$

where:
r₁=radial distance 1202a,
r₂=radial distance 1202b, and
r₃=radial distance 1202c.
   Various other location determination techniques can alternatively be used in embodiments of the present invention.

Thus, according to flowchart 1100, a physical location of client device 208 can be determined using multiple access points 202. Note that in another embodiment, a single access point 202 having multiple antennae and/or directional antennae may be able to perform flowchart 1100 to determine a location of client device 208

In embodiments, the determined physical location of client device 208 can be used to enhance security with regard to client device 208. For example, as shown in FIG. 13, a facility 1304 may include access points 202a-202d of network 200. Access points 202a-202d may locate client device 208 to determine whether client device 208 is in an acceptable location or an unacceptable location, and to act accordingly.

In an example, security module 504 shown in FIG. 5 may receive physical location indication 1214 shown in FIG. 12. In an embodiment, security module 504 is configured to determine whether the indicated physical location for client device 208 is outside a region authorized for operation of client device 208. For instance, in the example of FIG. 13, a determined physical location for client device 208 is outside of facility 1304, which may be an unauthorized area for client device 208. For example, this may indicate that client device 208 is associated with an item that was removed from facility 1304, or that an intruder using client device 208 is trying to access network 200 from outside facility 1304. Security module 504 may compare the determined location of client device 208 to a coordinate map indicating acceptable and unacceptable areas. Security module 504 may cause client device 208 to be decoupled from network 200, and/or enact other security measures, if the determined physical location is outside an acceptable area.

In another embodiment, security module 504 may be configured to validate communication packets received from client device 208. FIG. 15 shows a block diagram for client device 208, according to another embodiment of the present invention. As shown in FIG. 15, client device 208 includes RF communication module 902 and a location determiner module 1502. Client device 208 of FIG. 15 may further include the functionality described above with respect to FIG. 9. However, such functionality is not shown in FIG. 15, for ease of illustration.

In the embodiment of FIG. 15, location determiner module 1502 of client device 208 is configured to determine a physical location of client device 208. For example, location determiner module 1502 may determine a location of client device 208 in a similar fashion as location determiner module 210 of network 200. Thus, in an embodiment, client device 208 may include functionality shown in FIG. 12 for access point 202a used to determine a physical location for a client device. As shown in FIG. 15, location determiner module 1502 outputs a physical location indication 1504.

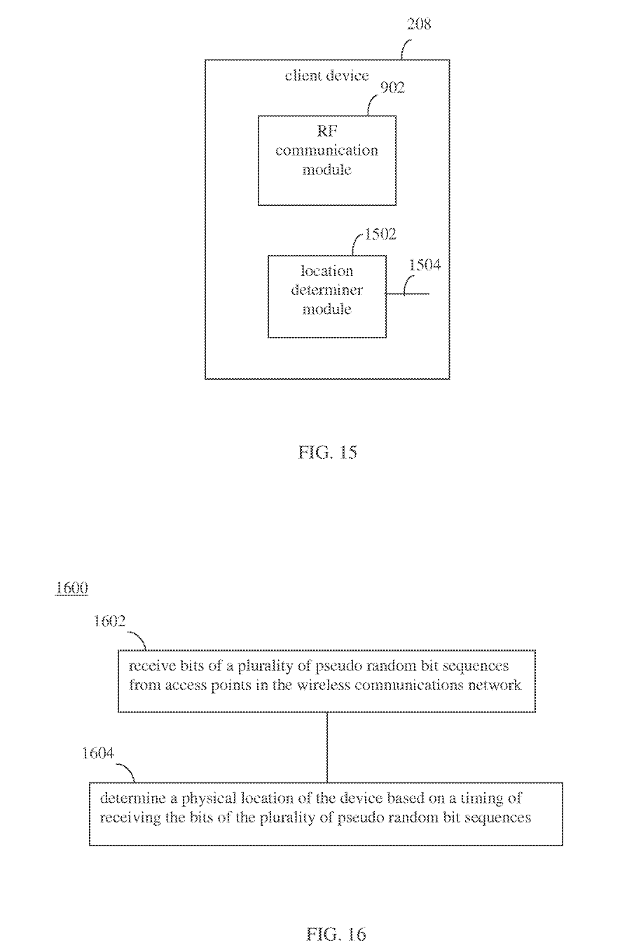

FIG. 16 shows a flowchart 1600 providing example steps in a client device for determining the location of the client device, according to an example embodiment of the present invention. The steps of flowchart 1600 do not need to be performed in the order shown in all embodiments. Flowchart 1600 is described as follows.

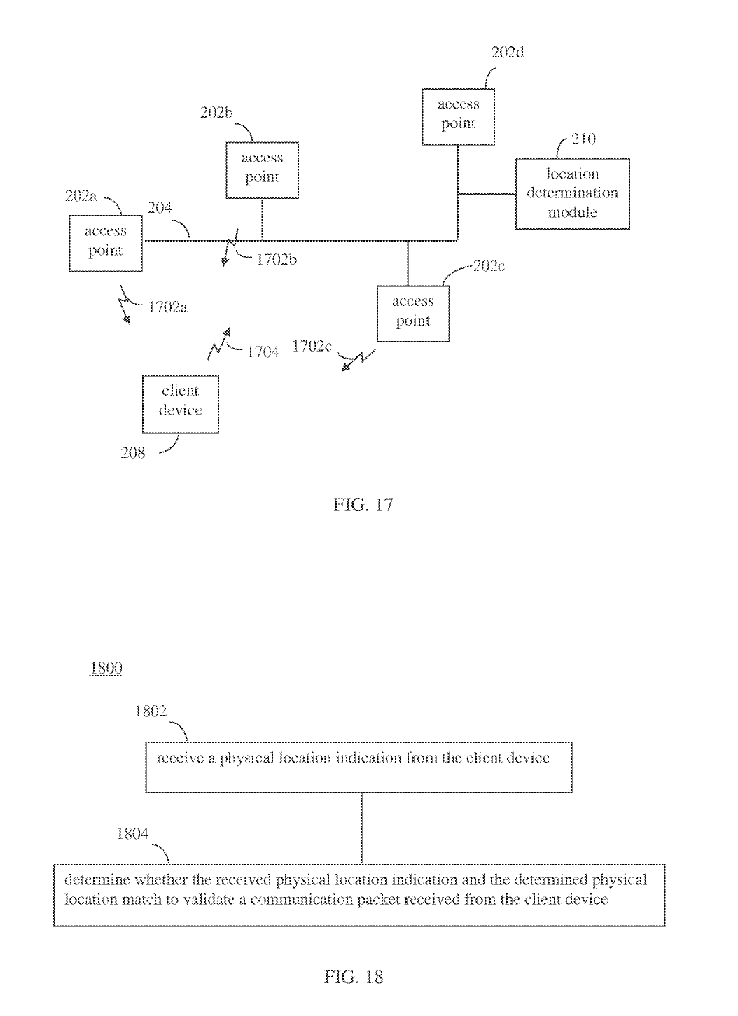

In step 1602, bits of a plurality of pseudo random bit sequences are received from access points in the wireless communications network. For example, FIG. 17 shows network 200, where access points 202a-202c transmit bit sequences 1702a-1702c. Bit sequences 1702a-1702c may be pseudo random bit sequences generated by pseudo random bit sequence generators 1202 in each of access points 202a-202c. As described above, the pseudo random bit sequences generated in access points 202a-202c are time-wise synchronized and matched with a pseudo random bit sequence generated in client device 208. Bit sequences 1702a-1702c are received by client device 208.

In step 1604, a physical location of the device is determined based on a timing of receiving the bits of the plurality of pseudo random bit sequences. In a similar fashion to as described above with regard to flowchart 1100, client device 208 may determine a time delay for receiving each of bit sequences 1702a-1702c, such as by comparing bit sequences 1702a-1702c to locally generated pseudo random bit sequence 920. The determined time delays may be used to determine radial distances to each of access points 202a-202c, which can be used by location determiner module 1502 of client device 208 to determine the location of client device 208. For example, techniques of triangulation, trilateration, or other techniques described elsewhere herein or otherwise known may be used. In an embodiment, position information for each of access points 202a-202c is provided to client device 208 to aid in determining the location of client device 208.

In an embodiment, client device 208 includes the physical location determined for itself in communication signals, such as a communication packet 1704 shown in FIG. 17, that are transmitted to network 200. Access points 202 of network 200 can use the received physical location information from client device 208 to validate the communication signals. For instance, FIG. 18 shows a flowchart 1800 providing example steps for validating communications with a client device, according to an example embodiment of the present invention. The steps of flowchart 1800 do not need to be performed in the order shown in all embodiments. Flowchart 1800 is described as follows.

In step 1802, a physical location indication is received from the client device. For example, as shown in FIG. 17, client device 208 transmits communication packet 1704 to network 200, where it is received by an access point 202, such as access point 202a. Communication packet 1704 includes physical location indication 1504 generated by client device 208. In an embodiment, physical location indication 1504 is encrypted in communication packet 1704, and is decrypted in the access point.

In step 1804, whether the received physical location indication and the determined physical location match is determined to validate a communication packet received from the client device. In an embodiment, security module 504 compares physical location indication 1504 received from client device 208 to a physical location indication 1214 generated within network 200 for client device 208 (e.g., according to flowchart 1100). Security module 504 determines whether physical location indication 1504 received from client device 208 matches physical location indication 1214 to validate communication packet 1704. Communication packet 1704 may be rejected (e.g., ignored, blocked from further processing, etc.) if security module 504 determines physical location indication 1504 does not match physical location indication 1214. Client device 208 may be decoupled from network 200, and/or further communications from client device 208 may be blocked if the match is not found. This additional layer of security provided by having a client device determine and transmit its own location information provides an additional way of authenticating communication packets received from the client device 208.

### Example Software Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system and to storing software in a computer system or other device. The invention, in an embodiment, is directed to such computer program products.

In an embodiment where aspects of the present invention are implemented using software/firmware, the software/firmware may be stored in a computer program product and loaded into a computer system or other device using a removable storage drive, hard drive, or communications interface. The computer system or other device may execute the software/firmware from storage such as a hard drive or memory device (e.g., a ROM device such as an electrically erasable ROM, electrically programmable ROM, a RAM device such as a static RAM, dynamic RAM, etc.). This control logic software/firmware, when executed by a processor, causes the processor to perform the functions of the invention as described herein.

According to an example embodiment, a WLAN device may execute computer-readable instructions to generate physical locations and/or perform security functions, as further described elsewhere herein, and as recited in the claims appended hereto.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for tracking client devices in a wireless communications network, comprising:
receiving a bit sequence at three or more access points of the wireless communications network from a client device communicatively coupled to the wireless communications network; and
determining a physical location of the client device based on a timing of receiving the bit sequence at the three or more access points.

2. The method of claim 1, further comprising:
determining whether the determined physical location is outside a region authorized for operation of the client device.

3. The method of claim 2, further comprising:
decoupling the client device from the wireless communications network if the determined physical location is determined to be outside the region.

4. The method of claim 1, further comprising:
enabling the client device to communicatively couple to the wireless communications network;
synchronizing a clock of the client device with a clock of the wireless communications network; and
providing a seed value to the client device for generation of the bit sequence.

5. The method of claim 4, wherein said determining a physical location of the client device based on a timing of said receiving the bit sequence at the three or more access points comprises:
generating a local version of the bit sequence at each access point of the three or more access points timed according to a network clock signal synchronized with the clock of the client device;
determining three or more time delays by determining an offset between bits of the bit sequence received from the client device and bits of the local version of the bit sequence generated at each access point of the three or more access points;
determining three or more radial distances by determining a radial distance for each of the determined three or more time delays; and
determining the physical location of the client device based on the determined three or more radial distances.

6. The method of claim 5, wherein said determining the physical location of the client device based on the determined three or more radial distances comprises:
using triangulation to calculate the physical location of the client device based on the determined three or more radial distances.

7. The method of claim 1, further comprising:
receiving a physical location indication from the client device; and
determining whether the received physical location indication and the determined physical location match to validate a communication packet received from the client device.

8. The method of claim 7, further comprising:
rejecting the communication packet if the received physical location indication does not match the determined physical location.

9. A wireless communications network, comprising:
a plurality of access points configured to enable client devices to communicate over the network; and
a location determiner module configured to determine a physical location of a client device communicatively coupled to the network based on a timing of receipt of a bit sequence from the client device at three or more access points of the plurality of access points.

10. The network of claim 9, further comprising:
a security module configured to determine whether the determined physical location is outside a region authorized for operation of the client device, and to cause the client device to be decoupled from the wireless communications network if the determined physical location is determined to be outside the region.

11. The network of claim 9, further comprising:
a clock synchronization module configured to synchronize a clock of the client device with a clock of the wireless communications network; and
a seed value generator configured to generate a seed value for the client device to use to generate the bit sequence.

12. The network of claim 11, wherein a local version of the bit sequence is generated at each access point of the three or more access points timed according to the clock of the wireless communications network;
wherein an offset between bits of the bit sequence received from the client device and bits of the local version of the bit sequence generated at each access point of the three or more access points is determined to determine three or more time delays;
wherein the location determiner module is configured to determine a radial distance for each of the determined three or more time delays to determine three or more radial distances; and
wherein the location determiner module is configured to determine the physical location of the client device based on the determined three or more radial distances.

13. The network of claim 12, wherein the location determiner module is configured to use triangulation to calculate the physical location of the client device based on the determined three or more radial distances.

14. The network of claim 9, further comprising:
a security module configured to determine whether a physical location indication received from the client device matches the determined physical location to validate a communication packet received from the client device.

15. The network of claim 14, wherein the communication packet is rejected if the security module determines the received physical location indication does not match the determined physical location.

16. The network of claim 9, wherein the wireless communications network is an IEEE 802.11 standard wireless local area network.

17. A method in a client device for communicating with a wireless communication network, comprising:
generating a local clock signal synchronized with a clock signal of the network;
generating a bit of a pseudo random bit sequence;
transmitting the generated bit at a predetermined value of the local clock signal; and
repeating generating a bit of the pseudo random bit sequence and transmitting the generated bit at a predetermined value of the local clock signal;
whereby a plurality of access points of the wireless communications network are configured to receive transmitted bits of the pseudo random bit sequence and to determine a physical location of the client device based on a timing of receipt of the transmitted bits.

18. The method of claim 17, further comprising:
generating the pseudo random bit sequence based on a seed bit sequence received from an access point of the wireless communication network.

19. The method of claim 17, further comprising;
receiving bits of a plurality of pseudo random bit sequences from access points in the wireless communications network; and
determining a physical location of the client device based on a timing of receiving the bits of the plurality of pseudo random bit sequences.

20. The method of claim 19, further comprising:
transmitting a communication packet that includes an indication of the generated physical location.

21. A device, comprising:
a radio frequency (RF) communication module configured to enable wireless communications over a wireless communications network;
a clock generator configured to generate a local clock signal synchronized with a network clock signal; and
a pseudo random bit sequence generator configured to generate bits of a pseudo random bit sequence;
wherein the RF communication module is configured to transmit bits of the generated bits at predetermined values of the local clock signal;
whereby a plurality of access points of the wireless communications network are configured to receive the transmitted bits and to determine a physical location of the device based on a timing of receipt of the transmitted bits.

22. The device of claim 21, wherein the pseudo random bit sequence generator is configured to generate the bits of the pseudo random bit sequence based on a seed bit sequence received from an access point of the wireless communication network, wherein the device further comprises:
storage configured to store the seed bit sequence.

23. The device of claim 22, wherein a plurality of pseudo random bit sequences are received from access points in the wireless communications network, wherein the device further comprises:
a location determiner module configured to determine a physical location of the device based on a timing of receiving bits of the plurality of pseudo random bit sequences.

24. The device of claim 23, wherein the RF communication module is configured to transmit a communication packet that includes an indication of the generated physical location.

25. The device of claim 21, wherein the device is an integrated circuit chip.

26. The device of claim 21, wherein the wireless communications network is an IEEE 802.11 standard wireless local area network.
